(19) United States
(12) Patent Application Publication
(10) Pub. No.: US 2015/0292264 A1
(43) Pub. Date: Oct. 15, 2015

(54) APPARATUS PROVIDING SINGLE SUPPORT TO AN EXTENSION LADDER ENABLING LADDER USE ON LEVEL AND NON-LEVEL SURFACES

(71) Applicant: SCOTT E. GREEN, DANSVILLE, NY (US)

(72) Inventor: SCOTT E. GREEN, DANSVILLE, NY (US)

(21) Appl. No.: 14/745,441

(22) Filed: Jun. 21, 2015

Related U.S. Application Data
(63) Continuation of application No. 13/065,910, filed on Apr. 1, 2011, now Pat. No. 9,068,395.

(51) Int. Cl. E06C 7/44; E06C 7/50

(52) U.S. Cl. CPC E06C 7/44; E06C 7/50

(57) ABSTRACT

An apparatus attachable to an extension ladder is provided having a single leg extendable in a direction perpendicular and adjacent to the two lowest rungs of an extension ladder, a channel bar sized to receive a substantial length of a lowest rung of the ladder, and a hook for latching onto a next to lowest rung of the ladder. A foot pivotally mounted to the leg at one end thereof supports the leg onto or at least partially into a level or non-level surface. A step member extends from the leg at an angle. When the ladder is extended upwards by a user, a removable arm member is received through a holder of the leg to lie against a user's leg to provide stability and prevent spinning. The apparatus when attached to the lowest two rungs elevates the ladder to be non-contact with the level or non-level surface.

### FIELD OF THE INVENTION

The present invention relates to an apparatus (attachment and method) providing a single support to an extension ladder enabling the ladder to be use on level and non-level surfaces, and particularly to, an apparatus attachable to the bottom two rungs of an extension ladder for supporting the entire ladder on a single leg over level and non-level surfaces. The apparatus is useful for adapting an extension ladder for use on non-level surfaces, which could not support the two legs of the extension ladder to enable safe climbing upon the ladder, and which can also be used on level surface without modification of the apparatus attached to the ladder.

### BACKGROUND ON THE INVENTION

An extension ladder has an upper and lower ladder portion which slide with respect to each other to adjust the height of the ladder. Each portion has two long parallel structural members, sides, or legs, which are coupled by equally spaced parallel rungs. Along the bottom of the two legs of the lower ladder portion are often swivel feet which pivot as needed such that the ladder may rest at an angle against a structure, such as tilted against the exterior of a home, building, or part thereof.

Typically, the upper ladder portion is extended with respect to the lower ladder portion by a user pulling on a rope attached near the bottom of the upper ladder portion which is fed through a pulley attached near the top of the lower ladder portion. The extension of the ladder typically occurs with the top of the ladder extending in the air and not leaning on any surface which could hinder sliding of the upper ladder portion with respect to the lower ladder portion. When the top of the upper portion of the ladder is at a desired position, a locking mechanism engages between the two ladder portions to enable safe climbing of the ladder, and the ladder is tilted to rest at an angle against the structure to be climbed.

For safe use of the extension ladder, the ladder is used on level or substantially level surfaces. If the surface is not substantially level, such as on a hill, steps, or any uneven surface which cannot evenly support the two legs of the extension ladder, safe use of the ladder is a problem. To address this problem, ladder levelers have been proposed which are either attached to one of the legs to extend the leg, such as shown for example in U.S. Pat. No. 3,933,222 to Craig, Jr., or attached to rungs adjacent to or near one leg of the two ladder's legs to effectively extending that leg, such as shown in U.S. Pat. No. 4,984,655, to Scherer et al., or U.S. Pat. No. 5,121,813 to Funston, or attached to both one of the ladder's legs and its rungs, such as shown in U.S. Pat. No. 5,174,412 to Vega. Other ladder levelers proposed have two separate devices each attached to one of the ladder's legs and are adjustable in length, such as shown in U.S. Pat. No. 6,435,306, to Stoneburg. A further more complicated ladder leveler is described in U.S. Pat. No. 6,378,656 to Kohler, which has a single unit attached to the bottom of both of the ladder's legs, and has two pivotal arms which lie on a surface.

In all of these ladder leveler devices, the ladder combined with the leveler device distributes the weight of the ladder down both of the ladder's legs to the ground, or other surface, via the ladder leveler device. Moreover, in most ladder leveler devices the devices need to be readjusted (e.g., in height) for use with the same ladder on different uneven surfaces, or removed from the ladder to enable use of the ladder on level surfaces. When a ladder leveler device is not present or not desired, holes are sometimes dug in a surface if possible, as in the case of a dirt or loose ground surface, to support one or both ladder legs, or block(s) of wood or other rigid material are sometimes placed under one or both ladder legs, to enables the feet of the ladder to be substantially level. However, these block(s) or leg(s) in dug holes can shift during ladder use creating a safety hazard to a climber on the ladder, and/or require another person to hold onto the ladder when used. Thus, a device easily attachable to an extension ladder, which is not a ladder leveler, is not complex, and enables the ladder to be used on level and non-level surfaces without modification (such as height adjustment) or removal of the device would be desirable.

### SUMMARY OF THE INVENTION

Accordingly, it is an object of the present invention to provide an apparatus attachable to an extension ladder which supports the ladder on a single leg, rather than on two legs extended all, or in part, by a ladder leveler device of the prior art, which enables the ladder to be used on different ones of level and non-level surfaces without modification or removal of the apparatus.

It is another object of the present invention to provide an apparatus attachable to a ladder which supports the ladder on a single leg whereby a user can extend (or retract) the ladder by himself or herself without the ladder spinning and possibly causing a dangerous situation by the user losing control over the ladder.

Briefly described, the apparatus (or attachment) embodying the present invention has a single leg extendable in a direction perpendicular and adjacent to the two lowest rungs of the lower ladder portion of an extension ladder, a channel bar attached perpendicular to the leg sized to receive a substantial length of a lowest rung of the lower ladder portion, a hook attached to the leg for latching onto a next to lowest rung of the lower ladder portion, a foot pivotally mounted to the leg at one end thereof to pivot the leg and foot with respect to each other along an axis of rotation, and a step member attached to the leg between the channel bar and the foot by one of more extension members at a downward angle to enable the step member to rotate upwards in a backward direction when the leg is rotated about the axis of rotation forward with respect to the foot. Such step member assists a user in ascending and descending the ladder, and if desired assists the user in seating the apparatus's foot on a surface. The apparatus further has a holder attached to the leg and an opening extending through the holder through which an arm member (such as a dowel, rod, or shaft) is receivable for extending from the leg at a downward angle to enable the arm member to rotate upwards in a backward direction when the leg is rotated about the axis of rotation forward with respect to the foot.

The angle of the extension members for the step member, and the angle of the arm member and the holder opening for receiving same, may be the same or different from each other. When the leg of the apparatus is attached by the channel bar and the hook to the two lowest ladder rungs, the ladder is elevated from the surface by the apparatus and non-contact with the surface, thereby providing a single support to an extension ladder enabling the ladder to be use on level and non-level surfaces. This is a result of the leg extending from the channel bar to the foot further than the lowest rung extends to lowermost part of the ladder's two legs.

When the leg is attached to the ladder's rungs by the hook and channel bar, and the upper portion of the extension ladder is being extended by a user upwards with respect to the lower portion of the extension ladder, such arm member is received through the opening of the holder such that the arm member lies against the user's leg to stabilize the assembly of the apparatus attached to the ladder and thereby prevent the ladder from spinning upon the attachment's leg and foot. This arm member may be removed prior to user climbing the ladder at its new extended height. The arm member may also be provided when the upper ladder portion is lowered with respect to the lower ladder portion by a single user.

The present invention also provides a method for attaching a single leg support to an extension ladder to enable the ladder to be use on level and non-level surfaces. The method having the steps of: providing a leg extendable in a direction perpendicular and adjacently behind at least the two lowest rungs of the lower ladder portion of an extension ladder; receiving in a channel of a bar along the leg a substantial length of a lowest rung of the lower ladder portion; latching the next to lowest rung of the lower ladder portion to the leg; pivotally mounting the leg at one end thereof to a foot to support the leg when present onto or at least particular into a level or non-level, in which the leg and the foot pivot with respect to each other along an axis of rotation; providing a step extending from the leg at an angle to enable the step member to rotate upwards in a backward direction when the leg is rotated about the axis forward with respect to the foot, in which the step extends from the leg between the bar and the foot; and providing an arm extending from the leg to enable the arm when located in a holder along the leg to stabilize the ladder against the leg of a user when the upper portion of the ladder is pulled via a rope upwards by the user to slide the upper portion with respect to the lower portion of the ladder in order to raise the ladder, and the arm is removable from the holder when the user climbs the ladder using the step. The arm when located in the holder may extend at an angle with respect to the leg to enable the arm to rotate upwards in a backward direction when the leg is rotated about the axis forward with respect to the foot.

The apparatus provides an attachment for an extension ladder which enables the ladder to be used on level and non-level surfaces without modification (e.g., height adjustment) or removal of the apparatus from the ladder.

### BRIEF DESCRIPTION OF THE DRAWINGS

The foregoing and other objects, features and advantages of the invention will become more apparent from a reading of the following description in connection with the accompanying drawings in which:

FIG. 1 is a perspective view of the apparatus of the present invention in which the leg of the apparatus is rotated forward with respect to the foot of the apparatus;

FIG. 2 is a front schematic view of the apparatus of FIG. 1;

FIG. 3 is a side schematic view of the apparatus of FIG. 1;

FIG. 4 is a perspective view showing an example of the apparatus of FIG. 1 attached to extension ladder along an angled surface and the ladder resting against a building structure;

FIGS. 5 and 6 are two perspective showing another example of the attachment of FIG. 1 when attached to an extension ladder, where FIG. 5 shows partially the ladder to illustrate use of the step member of the apparatus, and FIG. 6 shows same ladder as FIG. 5 with a user on the upper portion of the ladder;

FIGS. 7A and 7B are examples illustrating the apparatus of FIG. 1 in use when attached to an extension ladder, where an arm member, such as a dowel, of the apparatus is present to prevent the ladder from spinning upon the leg and foot of the apparatus when a rope in pulled by a user to raise the ladder such as from the position in FIG. 7A to the position in FIG. 7B; and

FIG. 7C is a more detailed view of the position of the arm member of FIGS. 7A and 7B abutting the leg of the user manually raising the extension ladder.

### DETAILED DESCRIPTION OF THE INVENTION

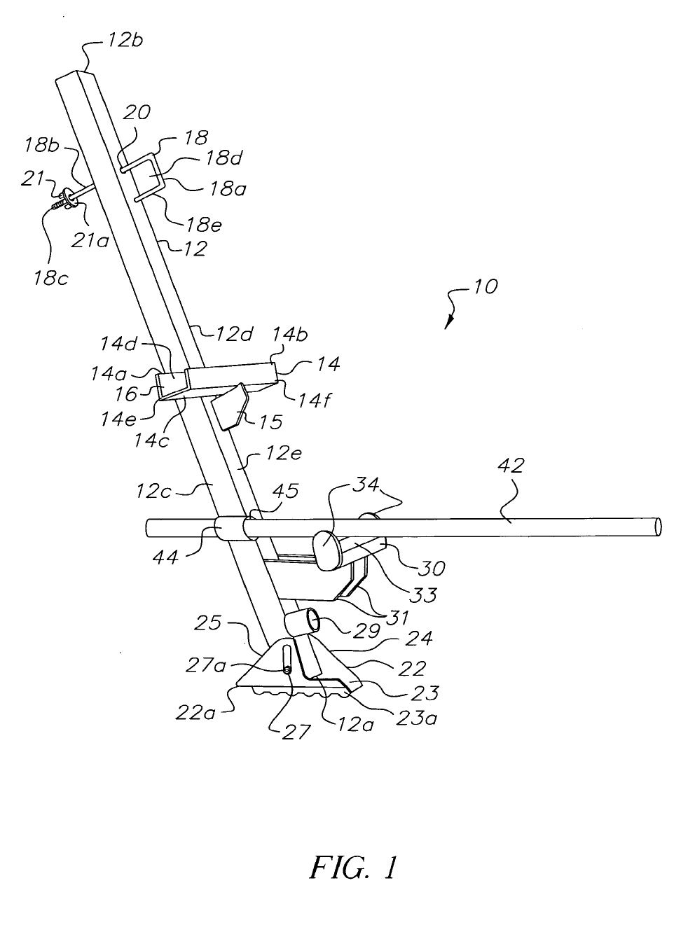

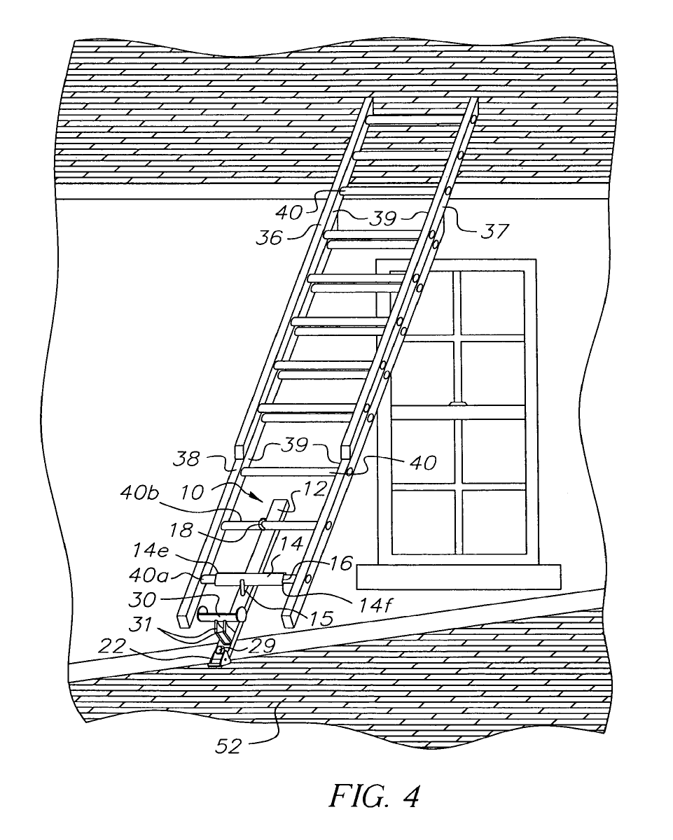

Referring to FIGS. 1, 2, and 3, an apparatus (or attachment) 10 of the present invention is shown having a leg 12 having two opposite ends 12a and 12b. For example, leg 12 may be a hollow square shaft of 1½ inch width per side, a length of 36 inches, and of 6061 aluminum material. A channel bar 14 is attached perpendicular to the leg and supported by a gusset (or bracket) 15. Channel bar 14, leg 12, and bracket 15 are attached to each other as shown in FIG. 1, such as by welding, but other attachment means may be used with or without bracket 15, such as by nuts and bolts. The channel bar 14 has a U-shaped cross-sectional channel 16 defined by two opposite side walls 14a and 14b, a flat bottom 14c, and an opening 14d, in which side wall 14a closer to leg 12 is slightly higher than side wall 14b. The channel 16 is sized to receive a rung of typical extension ladder. For example, side wall 14a may be 1⅝ inches in height; side wall 14b 1¼ inches in height, gusset ¼ inches thick, and the distance between the two side walls (i.e., width of channel 16) of 1 13/16 inches. Walls 14a, 14b, and 14c may each be ⅛ inches thick. Channel bar 14 is centrally attached about its length with respect to leg 12, and extends a substantial length of a rung (such as at least half the rung length) when a rung is received in its channel 16, but less than an entire rung length. When a rung is received in its channel 16, preferably the channel bar 14 is at least approximately centered about the rung between the two ladder's legs, and each end 14e and 14f of channel bar 14 is spaced a distance from one of the two ladder's legs (see e.g., rung 40a of FIG. 4). This distance varies depending on the overall length of the rung. For example, channel bar 14 is at least 10 inches in length, preferably 10½ inches. Ladder rung lengths vary by ladder manufacturer, but a common rung length for an extension ladder is 17 inches. Alternatively, channel bar 14 may extend the entire length of a rung, but this is less preferred since sometimes a rung has support members or braces near the two ladder's legs which if present would interfere with rung entry into channel 16. The length along leg 12 from channel bar 14 to shaft end 12a may be, for example, 16 inches.

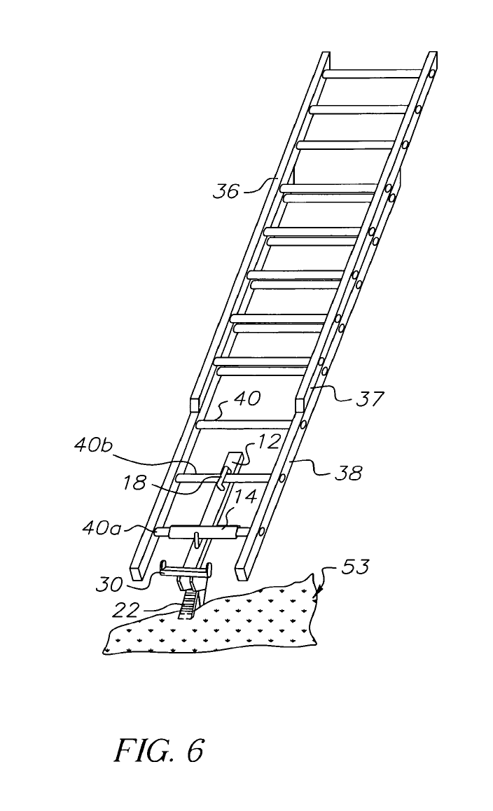

A hook 18 has a hook portion 18a extending to a straight portion 18b. The straight portion 18b extends though a hole 20 in the leg 12, and end 18c of the straight portion 18b is threaded for about 3 inches from its end so that a wing nut 21 can be screwed onto such end 18c. The hook 18 may be J-shaped and sized to receive a rung of a typical ladder in hook opening 18d, which extends from a hook end segment 18e and the part of the straight portion 18b opposite hook end segment 18e. A washer 21a is provided along straight portion 18b between leg 12 and nut 21. The wing nut 21 is used to enable hook 18 to latch a rung against leg 12 when receiving in hook portion 18a, and thus clamp hook 18 onto the rung. The interior width of hook opening 18d is equal to (or slightly more than) the width of a typical rung, such as 1½ inches, and end segment 18e may be about 1 inches long or other length sufficient to capture a rung in opening 18d. For example, hook 18 may be a stainless steel J-bolt which is ⅜ inch diameter, and bent to provide a hook as shown in the figures. Hole 20 of leg 12 is slightly larger in diameter than the diameter of hook 18 so that the straight portion 18b is movable longitude therein so as to enable capture and release of a rung by adjustment of nut 21. When a rung of a ladder is latched to leg 12 by hook 18, the nut 21 is hand tightened against leg 12 via washer 21a. The hole 20 for hook 18 is spaced a distance from the bottom of channel 16 of channel bar 14 so that when the channel 16 of bar 14 receives a lowest rung of a lower ladder portion of the extension ladder the hook 18 can receive and retain the next to lowest rung of the ladder, as shown for example in FIGS. 4 and 6. For example, hole 20 and bottom of channel may be a distance of 13 7/16 inches from each other.

The channel bar 14 and hook 18 are members dimensioned to receive the two lowest rungs of a ladder. For example, in the case of an extension ladder having rungs that are D-shaped in cross-section, i.e., a convex circular bottom and a horizontal top, the width along the rung's top may be 1⅝ to 1¾ inches, the rung's height from bottom to top may be 1½ inches, and the rung's length between two ladder's legs may be at or about 12 to 18 inches. In this example, channel bar 14 and hook 18 of apparatus 10 may have, for example, the following dimensions: hook opening 18d interior width at or approximately 1½ inches in order to capture a rung; channel 16 of 1¾ inches to 2 inches in width (preferably 1 13/16 inches); and channel bar 14 length at or greater than 10 inches, but less than 15 inches (preferably at or approximately 10½ inches). Thus, the same one of apparatus 10 can be used with a variety of different ladders of the same or different manufacturers having D-shaped rungs, or other cross-sectional shaped rungs (e.g., circular, rectangular, square, etc. . . . ) having at or about 1½ inches rung height, and other dimensions in or about the above stated ranges. The spacing between two adjacent rungs, as in the case of the lowest two rungs of a ladder, is generally the same between different extension ladders. The apparatus 10 may have its channel bar 14 and hook 18 sized to accommodate still other ladders (i.e., extension or non-extension types having only two legs for supporting the ladder upon a surface), so long as the two lowest ladder rungs can engage (lock, latch, or clamp) apparatus 10 via rungs into channel bar 14 and hook 18. Thus, one feature of the invention is that the apparatus 10 can be used with a variety of different ladders.

A foot 22 is pivotal mounted to end 12a of leg 12. The foot 22 may be typical swivel foot as used at the bottom of one of the legs of a typical extension ladder. Preferably, foot 22 has base or bottom wall or surface 23 with non-skid material 23a as typical of an extension ladder to assist in griping a surface, such as corrugated or grooved rubber. Extending upwards from the sides of the base 23 are two parallel flanges or triangular walls 24 and 25. A bolt, shaft, or pin 27 passes through a hole 28a of wall 24 (or 25), through hole 26 in each side 12d and 12c of leg 12, and then through a hole 28b of wall 25 (or 24). The two ends of bolt 27 are threaded and each has a nut 27a retaining the foot 22 onto leg 12 while enabling the foot to swivel or pivot as desired about an axis of rotation defined by the center through the length of bolt 27. One or both nuts 27a may be tightened as desired to lock the pivot position of leg 12 with respect to foot 22, and untightened to allow the foot to freely pivot about its axis of rotation about bolt 27. Such axis of rotation may be parallel to a dimension of the length of channel bar 14. For example, each of the hole 26 of leg 12 may be centered about ¾ inches from leg end 12a. Foot 22 helps prevent apparatus 10 from kicking out when apparatus 10 is attached to a ladder and presented upon a surface at a desired tilt with the ladder.

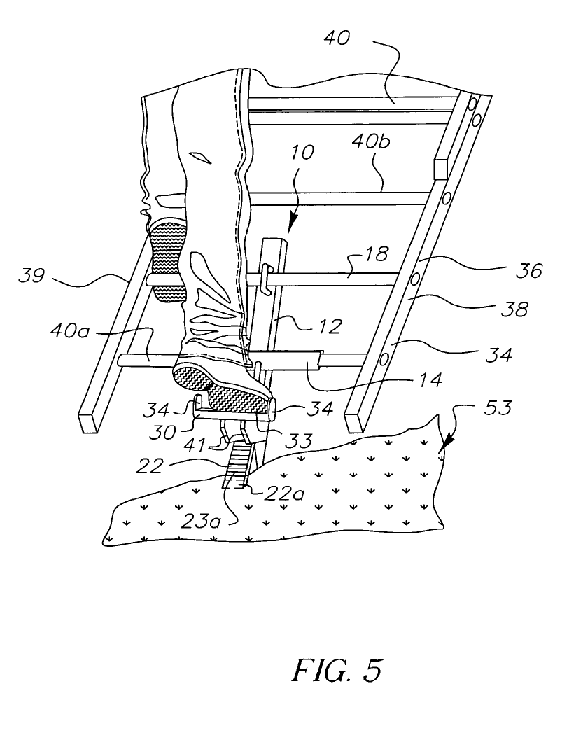

A stop or spacer 29 is attached to side 12e of leg 12 above the foot 22 so that interior of the bottom wall of foot 22 will abut stop 29 when the foot is pivoted (or rotated) against stop 29, and thereby hold the top of the foot, such as 1 inch, away from the leg. The foot 22 when so pivoted, base wall 23 lies at least approximately parallel with leg side 12e, enabling the back 22a of foot 22, sometimes called an “ice pick”, to be used to anchor apparatus 10 into a depth below a surface when needed for support, such as digging into ice, dirt, or other such material, such as shown in FIG. 5. The bottom of stop 29 may be about 2¼ inches from leg end 12a. For example, stop 29 may be a 1 inch diameter aluminum pipe attached to leg 12 as shown in the figures, however stop 29 may be a hollow or solid square, cylindrical, or other shape, and of other materials (e.g., rubber or polymeric) and attached by other means, e.g., adhesive or bolt and nut, to leg 12.

A step member 30 is attached to leg 12 between channel bar 14 and foot 22 by two extension members or flanges 31 which extend from along sides 12c and 12d, respectively. Members 31 are attached to leg 12 at a downward angle 32, such as 18 degrees, with respect to the normal 33 of a dimension extending along the leg's linear length between ends 12a and 12b of leg 12, as best shown in FIG. 3. However, other acute angular dimensions may be used. Members 31 may, for example, extend from leg 12 at angle 32 for about 6 inches. Step member 30 is attached at the end of the members 31 along the top thereof. For example, step member 30 may be a cylinder or pipe of about 6 inches centered about extension members 31. The two ends of step member 30 each have an end member 34. The stepping surface of step member 30 preferably has a non-skid (or skid resistance) layer 33 between end members 34. Such layer 33 may be attached by adhesive to step member 30 along an upper area thereof, or represent a coating applied to step member 30.

The attachment of step member 30 to leg 12 by members 31 at angle 32 is such that when leg 12 is rotated in a forward in a direction indicated by arrow 35 (FIG. 3) along the axis of rotation defined by bolt 27 of foot 22, such as to the position shown in FIG. 1, step member 30 rotates upward in the reverse direction to arrow 35 to raise step member 30 to a sufficient height to facilitate use of the step member's at a step for climbing (or descending) ladder 12 when attached to apparatus 10. Such angular rotation at or approximate to the degrees of angle 32 will extend step member 30 at or approximately horizontal. However, the amount of angular rotation depends upon that desired by the user for the particular ladder application. Although two members 31 are shown, alternatively, other attachment means to leg 12 may be used, such as single member (e.g., flange, bracket, or shaft) extending from leg 12 to step member 30 a sufficient length to enable use as a step and capable of supporting the weight of a user person when applied by the user's foot to step member 30. For example, step member 30 may be a 1 inch diameter pipe having ⅛ inch thick wall, and a length of 6 inches. End members 34 are located at the ends of the pipe, and extension members 31 are attached centered about the pipe's length.

The leg 12, bar 14, stop 29, members 30, 31, and 34, are preferably made of aluminum, and hook (or J-bolt) 18, washer 21a, and wing nut 21, are preferably made of stainless steel. Other materials may be used, in which weight bearing components, e.g., leg 12 and bar 14, are of material suitable for sustaining loads when present upon of a ladder. Foot 22 may be a commercially available ladder foot made of steel with a rust resistant coating. Bolt 27 and nuts enabling foot pivotal attachment to leg 12 may also be the same as those in attaching a typical swivel type foot to an extension ladder. Leg 12, bar 14, hook 18, stop 29, foot 22, members 30, 31, and 34 are attached as described above and shown in FIG. 1, such as by welding, or by other attaching means may be used.

The attachment of apparatus 10 to a typical extension ladder 36 is best shown in the examples of FIGS. 4, 5, and 6. Extension ladder 36 has an upper ladder portion 37 and lower ladder portion 38 which slides with respect to each other to adjust the height of the ladder 36, as typical of extension ladders. Each portion 37 and 38 has two long structural members or sides, called herein legs 39, which are coupled by equally spaced parallel rungs 40. The apparatus 10 is attached to ladder 36 when no person is on the ladder. Leg 12 is positioned adjacently behind at least the lower two rungs 40a and 40b so that the leg 12 extends perpendicular to such rungs, and the lowest rung 40a is received in channel 16 of channel bar 14, preferably centered or approximately centered between the lower portion's two legs 39. With nut 21 and washer 21a positioned on hook portion 18a, but away from leg 12, as shown for example in FIG. 3, the next to lowest rung 40b is received in opening 18d for capture, by hook 18 as described earlier, nut 21 is then tightened to latch rung 40b to leg 12, as shown in FIG. 4. There is no attachment of apparatus 10 to the legs 39 of ladder 36; the ladder is attached to apparatus 10 and supported solely by its two rungs 40a and 40b.

The ladder 36 when used is on a tilt such as shown in FIGS. 4-6 and leg 12 corresponds to such tilt by pivoting about its foot 22 which rests on a level or non-level surface. In FIG. 4 for example, this surface is an angled roof 52, while in FIGS. 5 and 6, the foot is pivoted against stop 29 so enable back 22a of foot 22 enters into the ground along the side of a hill 53 sufficient to anchor the apparatus 10 and ladder attached thereto. With foot 22 situated on or into (at least partially) a surface, and apparatus 10 is rotated or pivoted forward about axis of rotation along arrow 35 with the desired tilt of ladder 36 to a position enabling a user or person to climb the ladder with a top thereof resting upon a structure, step member 30 simultaneously rotates upwards in the reverse rotational direction to direction of arrow 35 to project step member 30 backwards and outwards approximately horizontally, as shown in FIGS. 5 and 6, or more than horizontal, as shown in FIG. 4, or less than horizontal, depending on the degree of ladder tilt desired and amount of angle 32. The leg 12 may be at the same or different position with respect to foot 22 than shown in FIG. 3 when attached to ladder 36.

Step member 30 has two functions. First, the step member 30 may be used for seating the foot 22 of apparatus 10 onto or at least partially into a surface (such as the ground) by the user applying with one of his or her feet downward force upon the stepping surface of step member 30 with the other one of his or her feet upon such surface. Typically, without the apparatus 10, such seating is performed using the lowest rung of the ladder, but here due to the lowest rung's increase height from the ground (or other surface) with attached apparatus 10, step member 30 is used. Ladder 36 is usable without such seating, but seating of the assembly of apparatus 10 and ladder 36 is preferred to reduce the change of slippage of the assembly during use. Second, step member 30 is used as a step to assist a user in climbing or ascending the ladder 36, as shown for example in FIG. 4, and for descending the ladder. Material 33 on step member 30 assists in reducing the risk of user foot slippage.

Along the bottom of the two legs 39 of lower ladder portion 38 may be swivel feet which are not used when apparatus 10 is attached to ladder 36. As such, the length along leg 12 from channel bar 14 to foot 22 is sufficient to elevate the two legs 39 of lower ladder portion 38 (and its swivel feet, if present) a distance from the level or non-level surface (and thus the ladder is non-contact with such surface). In other words, leg 12 extending from channel bar 14 to the bottom 23 of foot 22 further than the distance of the lowest rung along the ladder's two legs 39 to lowermost part or end of the ladder. Ladder 36 with apparatus 10, attached via only rungs 40a and 40b, may be moved to any level or non-level surface as desired without any modification (e.g., height adjustment) or removal of apparatus 10, since the foot 22 can pivot and engage such surface either along material 23a, or by digging into the surface via foot's back angled portion 22a, as needed.

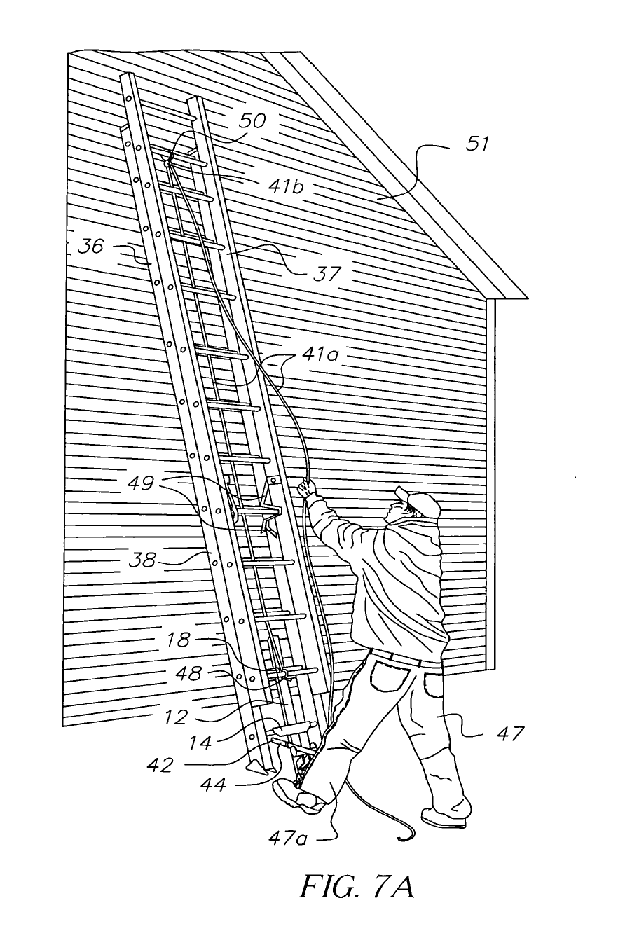

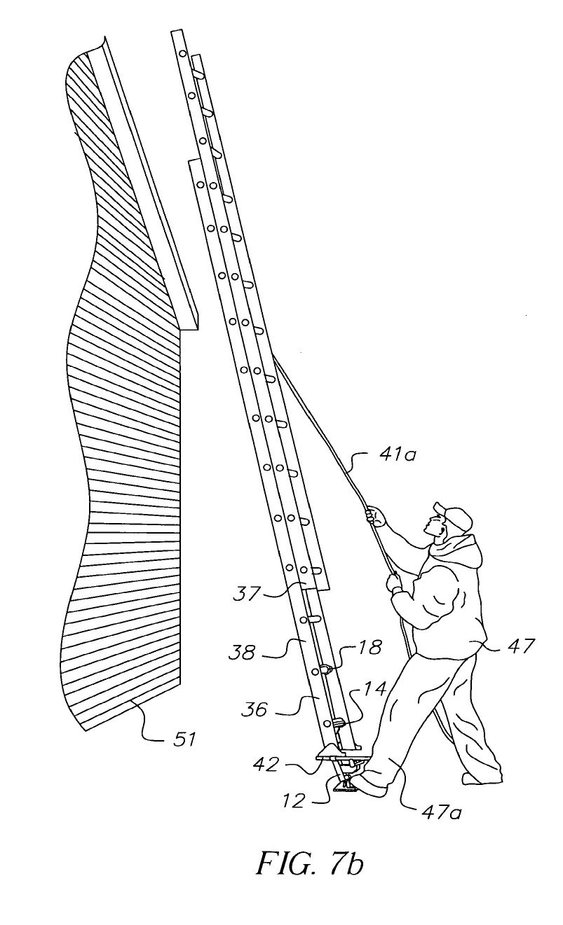

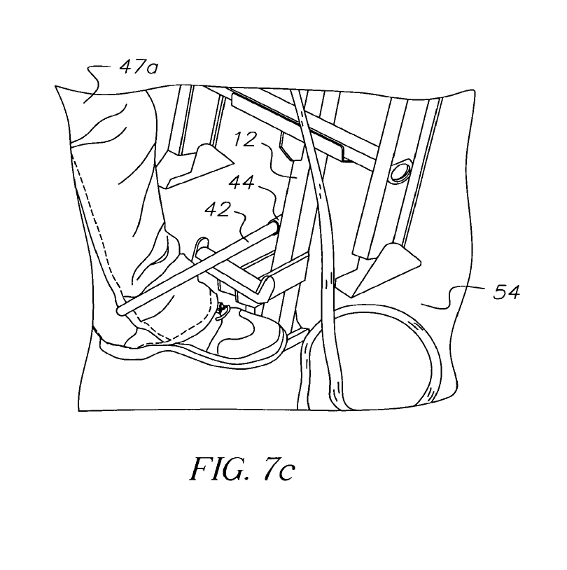

In the example of FIG. 4, the angle of roof 52 cannot provide a sufficiently level surface for ladder legs 39 of the lower ladder portion 38 to be used upon roof 52 without apparatus 10 attached to ladder 36 to provide a single support upon the roof 52. Similarly, in FIGS. 5 and 6, of hill 53 also represents a non-level surface which cannot provide a sufficiently level surface for legs 39 of the lower ladder portion 38 (even with the swivel feet at the ends thereof) to be used without apparatus 10 attached to ladder 36 to provide a single support level on hill 53. In a further example of FIGS. 7A-C, the same ladder of FIGS. 4-6 may also be used with apparatus 10 on an approximately or substantially level surface, such as provided by ground 54.

The ladder apparatus 10 distributes all weight of ladder 36 to one point down leg 12, thereby providing a single support attachment for the ladder. This is facilitated by channel bar 14 extending substantially the extent of rung 40a. Preferably, leg 12 is centrally (or at least approximately centrally) located between legs 39 of the lower portion behind rungs 40a and 40b, so that channel bar 14 and hook 18 are centrally (or at least approximately centrally) positioned along their respective rungs to promote ladder 36 stability when used.

Apparatus 10 is thus different from ladder levels, as described earlier, which distributes all weight of the ladder to two points along a surface. In other words, the weight of the ladder is distributed down both legs to the ground in which one or both of the legs are extended so that the ladder is level or approximately level. The ladder leveler devices of U.S. Pat. Nos. 4,984,655 and 5,121,813 utilize only rungs of a ladder are designed to distribute only part of the ladder weight along one side (i.e., leg) of a ladder, thus effectively extending one of the ladder's two legs. If devices of U.S. Pat. Nos. 4,984,655 and 5,121,813 were instead attached to a ladder to support the entire weight of the ladder on a surface, such would be extremely problematic due to inherent resultant ladder instability due to the manner in which their devices clamp onto the ladder. Ladder instability is undesirable since its can cause the ladder to tip as weight of a person is applied or shifted when present upon the ladder or when the body of limbs of a person on the ladder is extended from the ladder. Thus, not until the present invention has a single leg ladder support been safely attainable

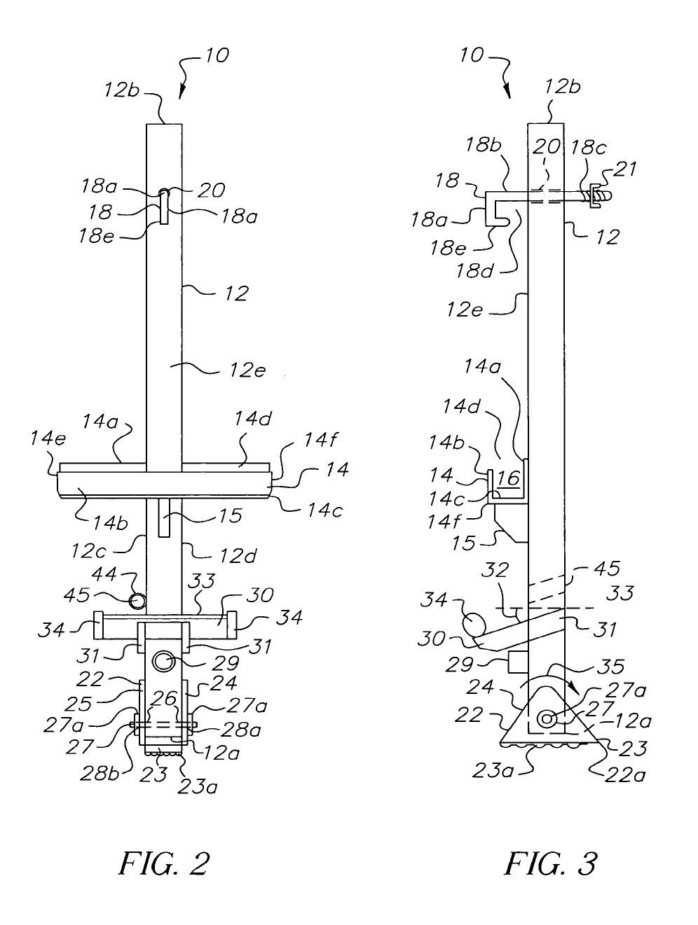

Due the ladder apparatus 10 distributing all weight of ladder 36 to one point down leg 12 to its foot 22, when upper portion of the ladder is extended from the lower portion as typically manually performed by a user pulling on a rope 41a attached near the bottom of the upper portion which is fed through a pulley 41b attached near the top of the lower ladder portion, would cause the ladder to undesirable spin or rotate about leg 12 and foot 22 causing the user to loose control and possible result in a dangerous situation. To avoid this situation, an arm member 42 is provided as shown in FIG. 1 to prevent spinning from occurring when a user raises or lowers the ladder by him or herself. Arm member 42 may be a dowel, as shown in FIG. 1, or a rod or shaft receivable in a holder 44 attached to side 12c of leg 12 about flanges 31. The holder 44 provides an opening or tube 45 extending through holder 44 and is of a size and shape to receive arm member 42, such that arm member 42 is slidable through opening 45. The opening 45 preferably extends at the same downward angle as members 31 for step member 30; however other acute angle to the normal of a linear dimension along the leg's length may be used. For example, opening 45 may be circular in cross-section to provide a tube having a diameter slightly larger than the diameter of the arm member 42 to enable the member 42 to be inserted and removed from tube 45, as needed. The holder 44 along leg 12 thus enables attachment and detachment of arm member 42 from leg 12. For purposes of illustration, arm member 42 is removed from holder 44 in FIGS. 2 and 3, and hidden from view in FIGS. 4 and 5.

FIGS. 7A-C illustrate the extending of ladder 36 using arm member 42. With the user 47 on the ground, and arm member 42 coupled to leg 12 via holder 44, the user pulls on a rope 41a attached near the bottom of the upper ladder portion 37, such as by a knot 48 about a rung, which is fed through a pulley 41b attached near the top of the lower ladder portion 38, such as to rung 50. While pulling on the rope 41a, the ladder 36 extends in the air and is not leaning on any surface which could hinder the sliding of the upper ladder portion 37. Also, pulling upwards the upper ladder portion 37 via rope 41a automatically release a locking mechanism 49 between the two ladder portions 37 and 38, or the user may operate the locking mechanism to disengage, as typical of an extension ladder to allow upper ladder portion 37 to slide with respect to lower ladder portion 38.

To stabilize ladder 36 when ladder portion 37 is being so extended, and thereby prevent spin of the ladder about leg 12 and foot 22 upon or in a level or non-level surface the arm member abuts a generally stationary member (separate from apparatus 10) provided by the user's leg 47a lying against arm member 42, such as illustrated in FIG. 7C. The arm member 42 is sized so as to extend away from leg 12 at least a sufficient distance to enable abutment with a user's leg when needed for stabilization. If desired, the user's foot may also be applied upon foot 22 to provide additional ladder stability (see FIG. 7C). When the top of the ladder (top of the upper ladder portion 37) is at a desired position, locking mechanism 49 engages when the rope 41a is slowly released by the user, and the ladder 36 is then tilted by the user using rope 31a or ladder 36 to rest ladder at an angle against the structure to be climbed with the ladder. Prior to climbing the ladder, preferably arm member 42 is removed from holder 44. Thus, arm member 42 is detached from apparatus 10 when a user is present on ladder 36. Arm member 42 may also be placed in holder 44 when upper ladder portion 37 is lowered with respect to lower ladder portion 38, if desired, to similarly prevent spin of the ladder 36 about the leg 12 and foot 22. The ladder 36 is shown as an example of one type or model of ladder which apparatus 10 can attach to for supporting the ladder, other ladders may similar to used with apparatus 10.

Preferably, anything capable of sliding into the opening 45 of holder 44 may be used to prevent spin of ladder 36 and attached apparatus 10 for stabilizing the ladder when the upper ladder portion 37 is moved in a controlled manner with respect to lower ladder portion 38. This allows a user, such as a contractor, to use anything in a pinch, such as dowel rod, long screw driver, jack handle, tree branch, etc., as one of arm member 42. Preferably, a dowel rod painted florescent color, such as orange, is used. For example, the dowel may be about 24 inches in length, and 1 inch in diameter The color facilitates locating the arm member 42 on a job site. As described above, with the arm member 42 inserted in (and preferably through) holder 44, the arm member 42 goes against the user's leg 47a, and stabilizes the ladder, holding it square with respect to a building 51 in the example of FIGS. 7A-C. The user 47 is able to continue pulling the rope 41a as shown in FIG. 7B, in order to extend the ladder 36 higher, where the user's leg provides a stop against arm member 42 preventing ladder spin. Once the ladder is extended and resting against the building 51 again, the arm member 42 can be removed from holder 44. Removing the arm member 42 from holder 44 does away with a potential tripping hazard, as well as making the ladder lighter to maneuver. The user can now go up and down the ladder safely. In other words, the arm member 42 is preferably used when raising or lowering the ladder 36 when the ladder is not against a structure, e.g., building as shown in FIGS. 7A and 7B, for example. Should the ladder 36 be against the building, arm member 42 is not needed. Further, arm member 42 may be provided in holder 44 of apparatus 10 attached to ladder 36 when the ladder is first being set up by a user prior to placement against a structure. Thus, apparatus 10 when attached to ladder 36 supports the ladder on a single leg and a user can extend or lower the ladder's upper portion by himself or herself without ladder spinning and possibly causing a dangerous situation by the user losing control over the ladder.

The apparatus 10 may be provided in a kit with or without arm member 42.

From the foregoing description, it will be apparent that an apparatus, attachment, and method of using such apparatus, providing a single support to an extension ladder enabling the ladder to be use on level and non-level surfaces has been provided. Variations and modifications of the herein described apparatus, attachment, and method for implementing the invention will undoubtedly suggest themselves, to those skilled in the art. For example, other dimensions of components described herein may be used. Accordingly the foregoing description should be taken as illustrative and not in a limiting sense.

1-29. (canceled)

30. An apparatus attachable to an extension ladder, said ladder having two sides and rungs extending between said sides, and said ladder having a lower portion and an upper portion movable with respect to said lower portion to raise or lower the height of the ladder, said apparatus comprising:
a single leg having members for latching the leg onto two adjacent rungs of said ladder, wherein said leg extends along a length parallel to the sides said the ladder;
a foot for supporting said leg upon a level or non-level surface, said leg solely supports said ladder, via said foot, in an elevated position above said level or non-level surface as a user safely climbs said ladder with said leg latched by said members to said ladder, and said length of said leg is non-adjustable in order to set height of the ladder above said level or non-level surface; and
another member attachable to said leg between said foot and a closest one of said members to said foot, in which said another member when attached to said leg extends away from said leg to stabilize said leg against a generally stationary member.

31. The apparatus according to claim 30 wherein said another member attached to said leg extends outward and away from said leg to stabilize said leg against a generally stationary member in order to prevent uncontrolled spinning of the ladder during movement of an upper portion of the ladder with respect to a lower portion of the ladder to raise or lower the height of the ladder when said leg is latched to said ladder and said foot supports said leg upon said level or non-level surface.

32. The apparatus according to claim 30 wherein said another member is attached to said leg during movement of an upper portion of the ladder with respect to a lower portion of the ladder to raise or lower the height of the ladder, and said members for latching said leg to said ladder operate independent of said another member.

33. The apparatus according to claim 30 wherein said another member is movable with respect to said leg, and said another member is moved from being a hazard to the user when climbing or descending the ladder when said leg is latched to said ladder by said members and said foot supports said leg upon said level or non-level surface.

34. The apparatus according to claim 30 wherein said leg is at least approximately centered between the sides of said ladder when latched by said members to said two adjacent rungs.

35. The apparatus according to claim 30 wherein said apparatus further comprises a step member attached to said leg between said foot and a closest one of said members to said foot, said step member provides a step for use by a user in climbing or descending the ladder when said leg is latched by said members to said ladder and said foot supports said leg upon said level or non-level surface.

36. The apparatus according to claim 35 wherein said foot is pivotally mounted at one end of said leg so that said step member, said leg and said ladder when latched by said members to said leg, all pivot together with respect to said foot in order to horizontally orient said step when said foot supports said leg upon said level or non-level surface.

37. The apparatus according to claim 30 wherein said foot is pivotally mounted at one end of said leg so that said leg and said ladder when latched by said members to said leg pivot together with respect to said foot when said foot solely supports said leg upon said level or non-level surface.

38. The apparatus according to claim 37 wherein said foot has bottom comprising a gripping surface and a pick portion, and said foot is pivotal to select one of said gripping surface and said pick portion for application to said level or non-level surface, in which selection of said pick portion positions said pick portion into a depth below said level or non-level surface, and selection of said gripping surface applies said gripping surface directly onto said level or non-level surface.

39. The apparatus according to claim 30 wherein said foot is pivotably mounted to one end of said leg at an axis or rotation, and said apparatus further comprising a step member attached to said leg, said step member having a major top surface and positioned between said first member and said foot, said step member configured to extend away from said leg at a first angle so that pivoting said leg backwards relative to said axis of rotation pivots said step member upwards relative to said surface to enable the major top surface of said step member to be horizontal to operate as a step for use by a user climbing or descending the ladder when said ladder is coupled to the attachment, said major top surface configured to be horizontal when a major length of said ladder and a major length of said leg are substantially angled with respect to horizontal.

40. The apparatus according to claim 30 wherein said another member is removable from a holder attached to said leg.

41. The apparatus according to claim 30 wherein one of said members extends along a least half a length of one of said two adjacent rungs between said sides of the ladder.

42. An apparatus attachable to an extension ladder, said ladder having two sides and rungs extending between said sides, and said ladder having a lower portion and an upper portion movable with respect to said lower portion to raise or lower the height of the ladder, said apparatus comprising:
a leg having members which latch the leg onto two adjacent rungs of a ladder;
a foot pivotally mounted to one end of said level to support said leg upon a level or non-level surface, wherein the ladder is supported in an elevated position above said level or non-level surface solely by said leg when latched to said ladder;
a step member attached to said leg, said step member having a top surface and positioned between said foot and a closest one of said member to said foot, said step member extends from a front of the leg at a downward angle when said leg is in an upright position, so that when said leg is tilted back from said upright position said step member moves upwards relative to said level or non-level surface to enable said top surface to present a step for use by a user in climbing or descending the ladder when said leg is latched to said ladder by said members; and
another member attachable to said leg to extend outward and away from said leg to stabilize said leg against a generally stationary member.

43. The apparatus according to claim 42 wherein when said leg is tilted back from said upright position said step member is movable upwards relative to said level or non-level surface to a horizontally orient said top surface.

44. The apparatus according to claim 42 wherein said another member is removable from said leg when said ladder is climbed by said user.

45. The apparatus according to claim 42 wherein said foot is pivotally mounted at a lower end of said leg to facilitate tilting of said leg when said foot is positioned on said level or non-level surface.

46. The apparatus according to claim 42 further comprising a holder attached to said leg which receives said another member.

47. The apparatus according to claim 42 wherein said another member attached to said leg to extend outward and away from said leg stabilizes said leg against a generally stationary member in order to prevent uncontrolled spinning of the ladder during movement of an upper portion of the ladder with respect to a lower portion of the ladder to raise or lower the height of the ladder when said leg is latched to said ladder by said members.

48. The apparatus according to claim 42 wherein said leg extends along a length parallel to the sides of said ladder, and said length of said leg is non-adjustable in order to set height of the ladder above said level or non-level surface.
